(19) United States
(12) Patent Application Publication
(10) Pub. No.: US 2012/0166244 A1
(43) Pub. Date: Jun. 28, 2012

(54) NOT-STARTED CUSTOMER RELATIONSHIP MANAGEMENT (CRM) DIALOGS

(75) Inventors: Hemant Raj, Hyderabad (IN); Sandhya Vankamamidi, Hyderabad (IN); Sutirtha Saha, Hyderabad (IN); Prabhat Kumar Pandey, Hyderabad (IN); Manish Arora, Hyderabad (IN); Devansh Dikshit, Hyderabad (IN); Subramanian Janardanan, Bellevue, WA (US); Nitin Mukhija, New Delhi (IN); Suhas H. Deshmukh, Hyderabad (IN); Ramesh Prasad Pandey, Hyderabad (IN); Vishal Srivastav, Hyderabad (IN); Priyesh Suman, Hyderabad (IN); Steven H. Kaplan, Seattle, WA (US)

(73) Assignee: MICROSOFT CORPORATION, Redmond, WA (US)

(21) Appl. No.: 12/980,152

(22) Filed: Dec. 28, 2010

(51) Int. Cl. G06Q 10/00

(52) U.S. Cl. 705/7.13; 705/304

(57) ABSTRACT

Not-started CRM dialogs are described to facilitate dialog management in a cooperative manner between a CRM system and a client. A workflow defining a set of actions to complete for a business process can trigger a dialog in a “not-started” state and assign the dialog to a particular user. Pending completion of the dialog, the workflow can be paused or continue in the background to a designated stopping point. The dialog that is assigned can appear in a list of scheduled/pending tasks for the particular user and can include a link or other functionality to resume the dialog. Selection of the dialog from the task list can cause the dialog to resume to an “in-progress” state and the status of the dialog can be updated. Thereafter, the workflow can detect completion of the dialog and continue with further actions to complete the business process.

### BACKGROUND

Through a customer relationship management (CRM) system, clients may be provided with resources to manage a variety of customer centric business processes, such as sales opportunities, product marketing, service calls, project management, and so forth. One technique for management of business processes is dialogs that can guide a user through a set of tasks assigned to the user in the context of a particular case or record for a business process. For example, a dialog can be employed to guide a service operator through a service call from a customer. In a traditional approach, stateless dialogs are triggered on the client-side in response to user action (e.g., by a user) and immediately become activated. Since these dialogs are interactive synchronous processes, the user may have to run the dialog to completion as soon as it is triggered. Requiring a user to trigger their own dialogs, though, can limit flexibility and make it difficult or impossible to assign dialogs, schedule dialogs, and/or track progress of the dialogs.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Not-started customer relationship management (CRM) dialogs are described that can be employed to implement dialog management in a cooperative manner between a CRM system and a client. In at least some embodiments, a workflow defining a set of actions to complete for a business process record can trigger a dialog in a “not-started” state and assign the dialog to a particular user. The workflow can then monitor for completion of the dialog. Pending completion of the dialog, the workflow can be paused or continue in the background to a designated stopping point. The dialog that is assigned can appear in a list of scheduled/pending tasks for the particular user and can include a link or other functionality operable to resume the dialog. Selection of the dialog from the task list can cause the dialog to resume to an “in-progress” state and the status of the dialog can be updated. Thereafter, the workflow may detect completion of the dialog and continue with further actions to complete the business process record as appropriate.

### BRIEF DESCRIPTION OF THE DRAWINGS

The same numbers are used throughout the drawings to reference like features.

FIG. 1 illustrates an operating environment in which various principles described herein can be employed in accordance with one or more embodiments.

FIG. 2 illustrates an example scenario involving a not-started CRM dialog in accordance with one or more embodiments.

FIG. 3 is a flow diagram that describes steps of a method in accordance with one or more embodiments.

FIG. 4 is flow diagram that describes steps of another method in accordance with one or more embodiments.

FIG. 5 illustrates an example computing system that can be used to implement one or more embodiments.

### DETAILED DESCRIPTION

Overview

Not-started customer relationship management (CRM) dialogs are described that can be employed to implement dialog management in a cooperative manner between a CRM system and a client. In at least some embodiments, a workflow defining a set of actions to complete for a business process record can trigger a dialog in a “not-started” state and assign the dialog to a particular user. The workflow can then monitor for completion of the dialog. Pending completion of the dialog, the workflow can be paused or continue in the background to a designated stopping point. The dialog that is assigned can appear in a list of scheduled/pending tasks for the particular user and can include a link or other functionality operable to resume the dialog. Selection of the dialog from the task list can cause the dialog to resume to an “in-progress” state and the status of the dialog can be updated. Thereafter, the workflow can detect completion of the dialog and continue with further actions to complete the business process record as appropriate.

In the discussion that follows, a section titled “Operating Environment” is provided and describes one environment in which one or more embodiments can be employed. Following this, a section titled “Not-Started CRM Dialog Examples” describes an example scenario involving a not-started dialog in accordance with one or more embodiments. Next, a section titled “Example Methods” describes example techniques for not-started CRM dialogs in accordance with one or more embodiments. Last, a section titled “Example System” describes an example computing system and device that can be utilized to implement one or more embodiments.

Operating Environment

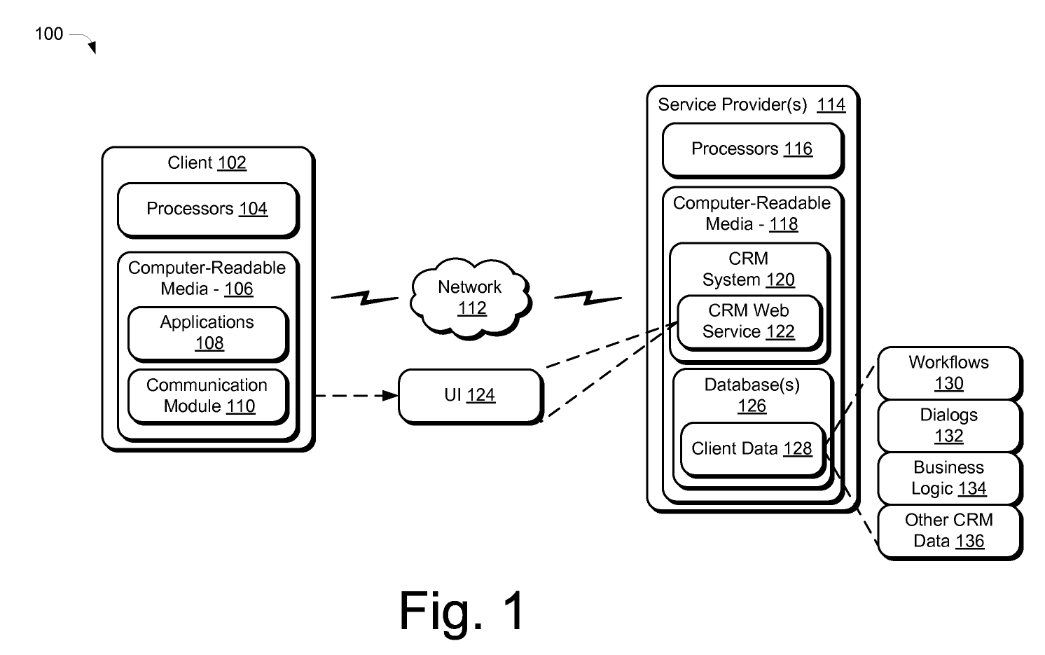

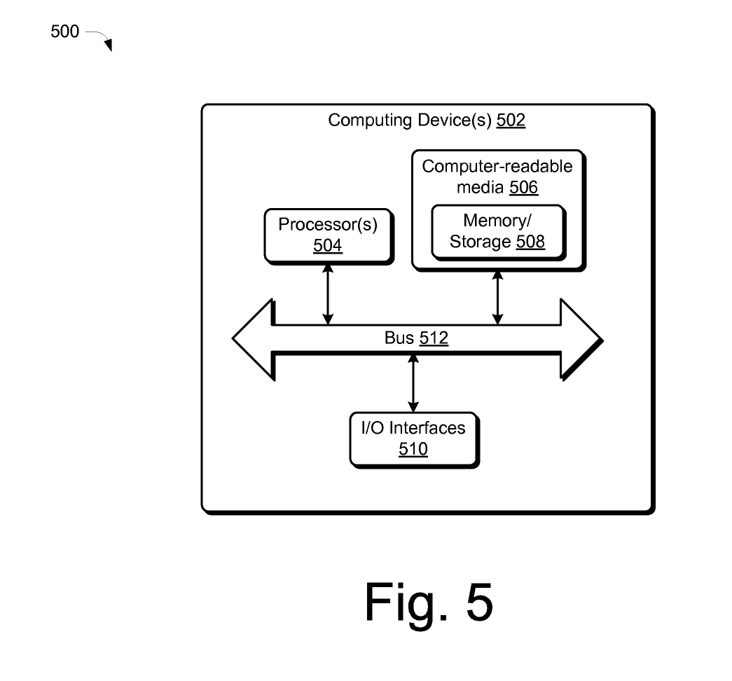

FIG. 1 illustrates an operating environment in accordance with one or more embodiments, generally at 100. Environment 100 includes a client 102 having one or more processors 104, one or more computer-readable media 106 and one or more applications 108 that reside on the computer-readable media and which are executable by the processor(s). The client 102 can be embodied as any suitable computing system and/or device such as, by way of example and not limitation, a desktop computer, a portable computer, a handheld computer such as a personal digital assistant (PDA), a cell phone, a set-top box, and the like. One example of a computing system that can represent various systems and/or devices including the client 102 is shown and described below in FIG. 5.

The computer-readable media can include, by way of example and not limitation, all forms of volatile and non-volatile memory and/or storage media that are typically associated with a computing device. Such media can include ROM, RAM, flash memory, hard disk, removable media and the like. Computer-readable media can include both “computer-readable storage media” and “communication media,” examples of which can be found in the discussion of the example computing system of FIG. 5.

In addition, client 102 includes a software application in the form of a communication module 110. The communication module 110 represents functionality of the client 102 operable to communicate with and interact with various other entities (e.g., other clients, providers, servers, web sites). For example, the communication module 110 may be configured as a web browser. Interactions with other entities can include sending and receiving electronic messages in various forms (e.g., e-mail, instant messages, application specific notifications, text messages, and so forth) between the entities, obtaining resources (e.g., content and services) from the other entities, and so forth.

For instance, the client 102 can be communicatively coupled over a network 112, such as the Internet, with one or more service providers 114 from and to which content can be received and sent. The service providers 114 are each depicted as having one or more processors 116 and one or more computer-readable media 118. A service provider 114 can be implemented by way of one or more server devices. Accordingly, various example components represented and described for a service provider 114 can be included on a single server device and/or can be divided between multiple different server devices.

The service provider 114 is depicted as including a customer relationship management (CRM) system 120. The CRM system 120 represents functionality operable by a service provider 114 to provide various CRM related resources to the client 102 over the network 112. For example, the CRM system 120 can include or otherwise make use of CRM web service 122 to provide various resources to assist clients in management of business processes, including but not limited to sales opportunities, product marketing, service calls, and so forth. The CRM system 120 provides a set of standard resources that clients 102 may take advantage to manage the business processes as well as custom and customizable resources that clients can adapt to fit particular operating procedures, processes, product characteristics, personnel structures, and other custom practices.

In at least some embodiments, the CRM system 120 makes resources available by way of web pages, HTML pages, application UIs, or other user interfaces 124 that are communicated over the network 112 via the CRM web service 122 for output by the client 102. The CRM system 120 can manage access to the resources, performance of the resources, configuration of user interfaces 124 or data to provide the resources, and so on. The client 102 can access the user interfaces 124 via a communication module 110, such as a browser. One or more applications 108 can also be configured to access user interfaces 124 and/or other CRM related resources. For example, a personal information management (PIM) client application or other desktop application 108 can make use of a CRM add-in that interacts with the CRM system 120 to obtain CRM related resources. In a particular example, a PIM client application can be employed to facilitate scheduling of actions, tasks, calls, and/or other events associated with particular CRM cases/projects that are assigned to particular users for completion. One example of a PIM client application is Microsoft Outlook®.

In addition, the CRM system 120 can include or otherwise make use of one or more databases 126 configured to store a variety of different client data 128 related to business processes of clients 102 that are managed through the CRM system 120. As depicted in FIG. 1, client data 128 can include workflows 130, dialogs 132, and business logic 134.

Workflows 130 represent automated and/or asynchronous flows that can be run to completion without relying upon user inputs. The workflows 130 define a set of actions to complete for a particular business process case or project. A workflow 130 therefore represents a structure or template that can be triggered to automatically manage actions for a corresponding business process. For example, a workflow 130 may relate to processing a potential sales opportunity. The workflow in this example can perform management actions such as assigning tasks regarding the potential sales opportunity to users (e.g., employees or other personnel), tracking progress of the tasks, creating and routing documents, sending communications to appropriate personnel, facilitating approval processes, triggering subsequent actions based on preceding actions, and so forth. In general, the workflow 130 operates in connection with a particular case or record for a business process to control the flow of actions from initiation to completion of the instance. This can include triggering and assigning actions including dialogs 132 to personnel as appropriate along the way. Workflows 130 are therefore configured to automate back-end processing for corresponding business processes.

Dialogs 132 represent interactive or synchronous processes that involve user inputs to run to completion. The dialogs 132 can relate to various interaction activities defined by a business process and controlled by a workflow. A dialog can include or be loaded with data for a corresponding business process record (e.g., contextual data) as well as having interactive questions, answers, selections, and so forth that are designed to guide a user in completing one or more tasks in connection with the business process record. The dialog 132 therefore facilitates completion of front-end interaction activities that are driven by user inputs for a corresponding business process. For instance, a dialog can be implemented as a wizard-like interface that steps a user through a set of actions and pages to complete an assigned task, such as a sales follow-up call in the above example of a potential sales opportunity. In at least some embodiments, the dialogs 132 can be triggered by a workflow 130 in a “not-started” state to make it more efficient for a user to pull-up, interact with, and complete the dialog, details of which are discussed in relation to the following figures.

Business logic 134 represents business specific logic that can be used to drive workflows 130 and/or define custom activities, dialogs 132, tasks, and so forth. Different business logic 134 is typically associated with each particular business entity that uses the CRM system 120. Thus, business logic 134 can represent data that defines the structure, steps, flow, and/or personnel involved in business processes for a business entity. A variety of other CRM data 136 is also contemplated examples of which include case records, contact lists, task management tools, operational data, product documentation, support data, pricing data, customer account information, and so forth.

Having described an example operating environment, consider now a discussion of some not-started CRM dialog examples in accordance with one or more embodiments.

Not-Started CRM Dialog Examples

In one or more embodiments, not-started CRM dialogs can be implemented by a CRM system 120 to initiate dialogs in a pending manner on behalf of clients 102. By so doing, the client 102 does not have to initiate a dialog session on their own. Instead, the CRM system 120 can assign and schedule dialogs 132 on behalf of users, such as using a PIM application or a web accessible client user interface 124. This can enable a user to view dialogs 132 as pending tasks in a task list exposed by the CRM system. Users may further be able to simply select a link or other selectable control provided in conjunction with a pending task to resume, pull-up, interact with, and complete an assigned dialog 132.

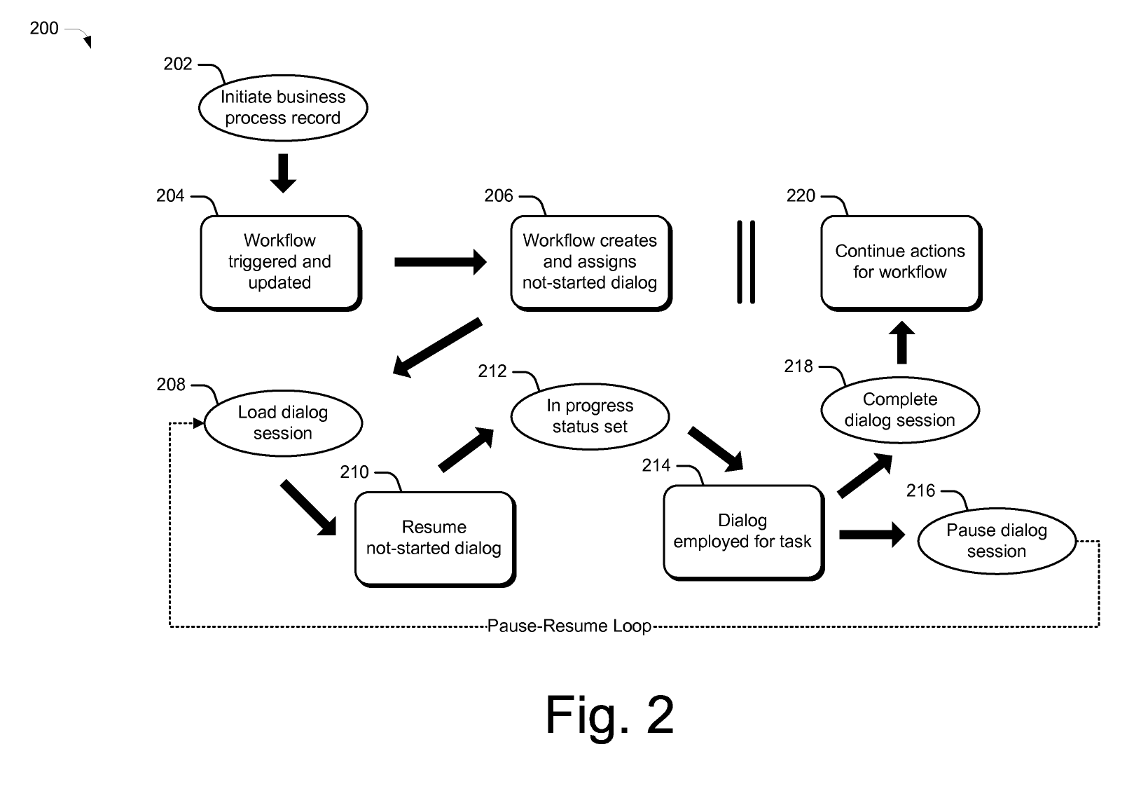

In this context, consider the following scenario that illustrates some example aspects of not-started dialogs. In particular, FIG. 2 depicts a diagram 200 in which a not-started CRM dialog is created and used in connection with a business process record. At step 202, a business process record is initiated. This can occur in any suitable way. For example, a business process record may be created for each case or project that is managed through the CRM system 120 to store data related to the case or project. A case or project as used herein corresponds to an instance of a business process, such as a particular sales opportunity, customer service case, engineering project, and so forth. In at least some embodiments, a user may interact with the CRM system 120 to make selections and/or input data to create a new record or instance of a business process. Additionally or alternatively, the CRM system 120 may be configured to automatically initiate business records upon the occurrence of designated events or triggers. For example, a call handling record can be initiated automatically by the CRM system 120 in response to monitoring of calls placed to a customer service center.

At step 204, a workflow corresponding to the business process is triggered. As noted above, a CRM system 120 can provide management for various business processes including sales, marketing, service, and other processes through corresponding workflows 130. Workflows 130 can be designed for different kinds of cases/projects such as sale opportunities, sales calls, order management, a marketing campaign, service calls, competitor analysis, invoicing, and so on. More generally, it is contemplated that a wide variety of business processes can be managed using a CRM system 120, workflows 130, dialogs 132, business logic 134, and so forth. Thus, the techniques described herein can be applied to a wide variety of processes in addition to the examples mentioned above such as engineering projects, building projects, software development projects, and case management for legal, business, and/or other professional services, to name a few other examples. Custom business logic 134 can be used to model these processes and/or implement corresponding workflows 130 to manage the process steps.

Thus, when a particular business process record for some type of case or project is initiated, this can trigger a corresponding workflow 130. The workflow 130 can be updated with data specific to the particular record, such as by populating appropriate data fields with client data 128 related to the record. This provides the context for the workflow 130. The workflow 130 as noted can operate asynchronously to perform an automated set of actions for the corresponding business process. The workflow 130 therefore can automatically begin execution to perform various back-end processing. This back-end processing includes controlling the flow of both back-end and front-end actions. To do so, the workflow 130 is configured to perform back-end actions, trigger and/or assign front-end interaction activities (e.g., dialogs) to appropriate personnel, monitor the front-end interaction activities, obtain results of the back-end actions and front-end interaction activities, and make decisions on processing steps to take next to manage the flow based on results obtained from preceding steps.

Front-end interaction activities controlled by a workflow 130 can include one or more dialogs 132 at least some of which are created in a not-started state. For example, in step 206, a dialog session in a not-started state is created and assigned. This can occur at any point in a workflow 130 and/or can occur multiple times in the execution path of the workflow 130. For instance, the CRM web service 122 can be implemented to trigger a dialog 132 in response to various back-end actions. In one example, a dialog 132 to obtain potential customer contact information can be triggered in connection with a potential sales opportunity. In another example, a status report dialog can be triggered in connection with a meeting scheduled for an engineering project.

More particularly, step 208 loads a session for a dialog 132 that is related to the business process record. The session for the dialog is in a not-started state. In other words, the dialog 132 is pending rather than being immediately active like traditional dialogs. Moreover, the dialog session is initiated from the workflow 130 rather than on the client-side. Accordingly, the CRM web service 122 can also assign the dialog to appropriate personnel as a pending task. Accordingly, a workflow 130 can create a dialog session in a not-started state that is assigned to a user and then convey information to prompt the user to run the dialog in various ways. Pending completion of the dialog 132, the workflow 130 can be paused or may continue back-end processing. In some cases, additional back-end processing can occur up to a stopping point where feedback from the dialog 132 might be used to determine the next steps. Accordingly, the workflow 130 can proceed to the stopping point, pause, and await results of the dialog 132 before moving forward.

In at least some embodiments, the CRM system 120 can automatically create tasks for one or more users using scheduling functionality integrated with or otherwise accessible via the CRM system 120. For example, the CRM system 120 can be configured to schedule tasks using a Personal Information Management (PIM) program such as Microsoft Outlook®, a messaging service, a web-based calendar, and/or other suitable integrated or third-party application that enables scheduling functionality. The CRM system 120 can also operate to notify users in any suitable manner regarding assigned tasks including those created for not-started dialogs.

In one approach, the CRM system 120 can create tasks for a list of pending tasks that users can access and view through the CRM web service 122, such as by using a CRM client of the CRM system 120 accessible via a browser. The CRM system 120 can also operate in conjunction with a PIM application, a desktop CRM application, or other application 108 of a client 102 to cause assigned tasks to appear in corresponding tasks lists. The CRM system 120 can also send notifications regarding tasks in various forms to appropriate personnel including but not limited to sending one or more of instant messages, e-mail alerts, pop-up messages, toast messages, visual alerts within a CRM client user interface, and so forth.

Tasks for not-started dialogs included in a task list and/or notifications sent regarding the tasks can be configured to include links or other controls (e.g. buttons, a dialog icon, toolbar item, and so forth) selectable to navigate to a corresponding dialog 132. For instance, the title of a task or notification may incorporate a link to a URL that when selected causes navigation to an associated not-started dialog. Thus, a user can view pending tasks and can quickly make selections to navigate to complete dialogs 132 associated with tasks. Additionally or alternatively, a user can also navigate directly through selectable controls included with a notification sent regarding tasks having corresponding not-started dialogs.

Thus, on the client-side, a user can view and be notified regarding pending tasks including those associated with dialogs and can simply select different pending tasks to work on corresponding items. At block 210, selection of a link or other control for a not-started dialog causes the not started dialog to resume. In particular, the dialog session created per step 208 is resumed from the not-started state to an active or “in-progress” state. At step 212, the resumption of the dialog can be communicated to the CRM system 120 and accordingly the status of the dialog can be set to in-progress. For example, a client 102 may be configured to send communications regarding the status of dialogs and tasks back to the workflow 130. This enables the workflow 130 to track progress of various dialogs and tasks that can be initiated by the workflow 130 and take responsive actions such as creating progress reports, sending reminders, escalating matters to a supervisor, and so forth.

At step 214, the dialog is employed for the corresponding tasks. For example, the now in-progress dialog runs and the user can follow the actions specified by the dialog. The dialog for example can be provided through a user interface 124 that is accessible from the CRM web service 122 over the network 112. The dialog 132 can include a number of wizard like pages that are designed to guide the user through the task, accept input and comments, record data for the task, and so forth. In the example of a customer service call, for instance, a dialog can guide a support person through steps to gather customer information, obtain product information, troubleshoot a problem, ship a replacement product or part if appropriate, or otherwise handle the customer service call in accordance with business practices that are encoded in the dialog 132.

Input obtained and operations performed per step 214 for a dialog are used to complete the tasks associated with the dialog. Using the techniques described herein, a dialog can be completed through a single “in -progress” pass. Additionally or alternatively multiple iterative passes in which a dialog is paused and resumed can occur to complete a dialog using multiple loops. Accordingly, as shown in FIG. 2, following step 214, the dialog session can be paused per step 216 or completed per step 218.

Thus, in at least some embodiments, a pause-resume option can be provided to pause a dialog session before completion of the dialog. This can enable a user to work on a portion of the dialog, pause the dialog, and then resume the dialog at another time. One or more such pause and resume loops can occur for a particular dialog. When paused, the dialog can be placed in a non-started state. This can enable the dialog session to effectively be offloaded until a user/client interacts to resume the dialog. Then, the dialog can be resumed from the non-started state to the in progress state as described herein. This can occur by looping back one or more times to repeat steps 208-214 described herein as represented by the pause-resume loop in FIG. 2. In this manner, dialogs can be paused and resumed multiple times until the dialog is completed.

For example, in the context of a service call, a technical support representative can use a dialog to collect user information and some initial data on a customer problem. The technical support representative can then pause the dialog to perform research, consult with other people, and so forth. The technical support representative can then resume the dialog that was paused. This can cause the dialog to be reloaded and again placed into an in-progress state. Further input can be obtained and operations can be performed to complete the dialog per step 214.

When the dialog is completed following step 214, step 218 sends a communication indicative of the completion back to the CRM system 120, which can update the status of the dialog to “completed.” Then, at step 220 the workflow 130 can continue to perform additional actions for the business process record. This can involve resuming the workflow in the event that the workflow 130 is paused pending results of the dialog 132.

Results corresponding to a dialog 132 can be included in the communication indicating that the dialog is complete. These results can be stored as part of the business process record. The results can also be used to make determinations regarding additional steps to take in the workflow 130. For instance, in the example of the customer service call, if the problem was not resolved then additional tasks/dialogs to follow-up with the customer, research the problem, and so forth can be prompted by the workflow 130. On the other hand, if the problem is resolved, then the workflow 130 can create tasks/dialogs to close out the case or can simply close out the case if appropriate.

Having considered an example scenario, consider now example procedures for not-started CRM dialogs in accordance with one or more embodiments.

Example Methods

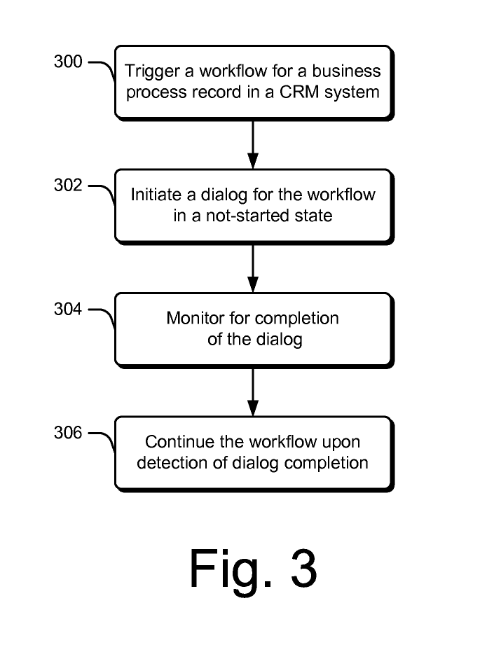

FIG. 3 is a flow diagram that describes steps of a method in accordance with one or more embodiments. The method can be implemented in connection with any suitable hardware, software, firmware, or combination thereof. In at least some embodiments, the method can be implemented by way of a suitably configured computing device, such as the example service provider 114 of FIG. 1 that includes or otherwise makes use of CRM system 120 and/or CRM web service 122.

Step 300 triggers a workflow for a business process record in a CRM system. Then, step 302 initiates a dialog for the workflow in a not-started state. Consider now a particular example in which a sales person completes a sale to a customer. This can occur in accordance with a business process that is defined for a sales opportunity. A workflow 130 designed to manage action for the sales opportunity can be triggered by the CRM system 120 when the case is initially created. In this example, the sales person as well as other personnel may have already completed a number of actions to handle the sales opportunity as directed by the workflow 130, which resulted in the sale to the customer. However, the sales person may have to obtain some follow-up information from the customer over the phone.

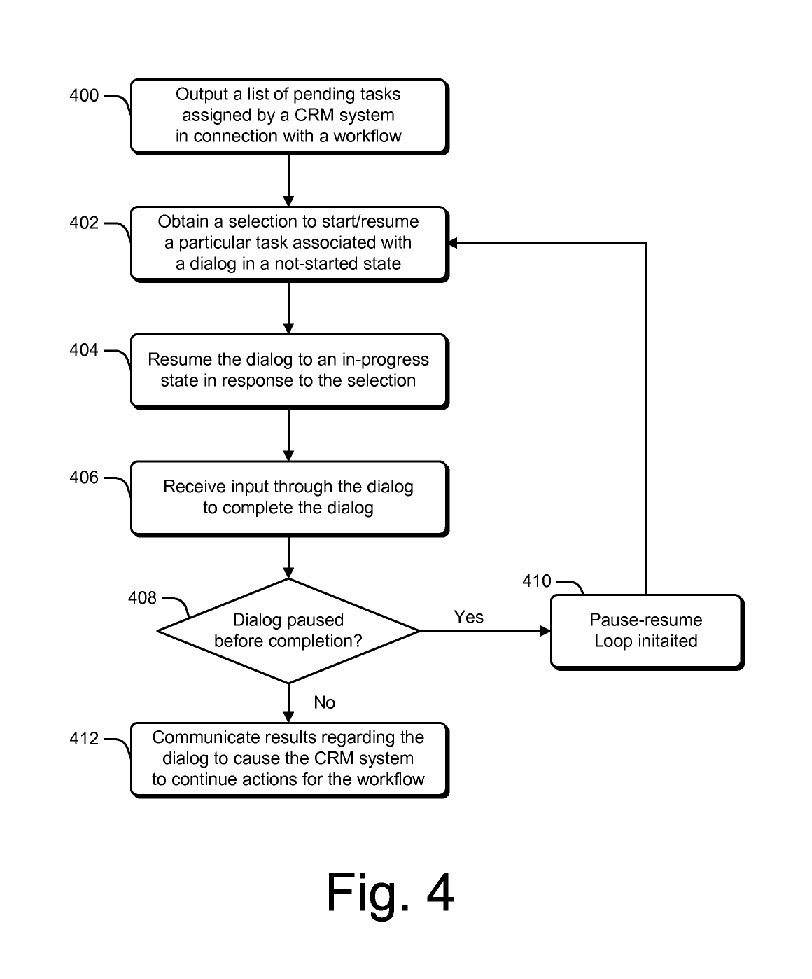

Here, the workflow 130 can be configured to create a phone call activity that is assigned to the sales person. This can occur at various times such as initially when the case is created, in response to one or more preceding tasks or dialogs, upon a selection by the sales person to schedule the phone call, and so forth. The workflow 130 can also operate to initiate a phone call dialog in connection with the phone call activity that is designed to assist the sales person in gathering follow-up information from the customer. The dialog can be initiated in a not-started state as described above and below. The workflow 130 can further cause the activity and corresponding dialog to be assigned to the sales person and can load the dialog with client data 128 that is collected through previous steps of the workflow. Accordingly, the dialog is made available for the sales person when the sales person is ready to make the call. The sales person can access the dialog through a task list or notification as previously described. Further aspects related to processing a not-started dialog can be found in the discussion of the example method of FIG. 4 below.

Step 304 monitors for completion of the dialog. As noted previously, a workflow 130 can continue processing and/or reach a stopping point pending completion of a dialog. In either case, the workflow 130 can monitor to determine when the dialog is complete. When completion of the dialog is detected, step 306 continues the workflow. For instance, completion of the dialog can drive further actions in the workflow. At least some of these actions can be dependent upon results of the dialog. In the sales call example, updated customer contact information and/or sales terms can cause the workflow to update customer information stored as client data 128 using results of the dialog. In another example, another dialog or even a separate workflow can be initiated based on results of the completed dialog, such as to schedule a re-occurring order for the customer via an order handling system and corresponding personnel. It should be noted that multiple different workflows and dialogs can be driven by a single business process and/or in connection with multiple business processes. It is even possible for a dialog 132 to be configured to prompt child dialogs and/or trigger other workflows 130 if appropriate, details of which can be found in relation to the following method.

FIG. 4 is a flow diagram that describes steps of another method in accordance with one or more embodiments. The method can be implemented in connection with any suitable hardware, software, firmware, or combination thereof. In at least some embodiments, the method can be implemented by way of a suitability configured computing device, such as the example client 102 of FIG. 1 configured to interact with a CRM web service 122. For instance, the client 102 can makes use of communication module 110 and/or other application 108 to direct operation of the CRM web service 122 implemented via the service provider 114. The described steps represent actions that can be performed by the CRM web service 122 alone, by the client 102 alone, and/or by the CRM web service 122 and client 102 in combination.

Step 400 outputs a list of pending tasks assigned by a CRM system in connection with a workflow. For instance, a particular user can access and view a list of pending tasks that are assigned by the CRM system 120 in various ways described above and below. One way this can occur is through a browser that interacts with a CRM web service 122 to obtain a user interface 124 for output by a client 102. Further, a PIM application or other application 108 can be used to obtain a list of pending tasks that is output via corresponding user interfaces 124. Individual tasks can also be communicated through various notifications. In the example above involving a sales call, the sales person can access a list of pending tasks or obtain a notification that describes the phone call activity associated with a not-started state dialog.

Step 402 obtains a selection to start a particular task associated with a dialog in a not-started state. In response to the selection, step 404 resumes the dialog to an in-progress state. Then, step 406 receives input through the dialog to complete the dialog.

Selection of a particular task can occur in any suitable way including through a task list and/or notifications accessible through a browser, a PIM application, or other application that enables interaction with the CRM web service 122. In the continuing example, the sale person can make a selection by selecting a title for a task in a task list that is configured with a link to a URL selectable to cause the corresponding not-started dialog to resume. In response to selection of the link, the dialog is resumed in an in-progress state and the sales person can make the sales call guided by the dialog. The dialog can include various prompts and responses to direct the sales call. The sales person can fill-in data fields, comments, and provide other inputs that can be collected through the dialog for association with a corresponding record.

In at least some embodiments, a particular dialog can cause a child dialog to be created by the CRM system 120. A child dialog can be triggered based upon one or more triggers encoded in the parent dialog. The triggers can include data values or thresholds, defined events, particular selections made via the dialog, and/or other suitable triggers. The child dialog can be created in a not-started state and be assigned to the same or a different user. The child dialog can be configured to include data that links the dialog to the original dialog and describes the appropriate context. A dialog can even initiate other workflows 130 for the same or a different business process if appropriate.

For example, assume in the follow-up call, the customer decides to increase the quantity of a product order. This order increase can trigger a dialog that is assigned to an order handling representative to confirm that the requested volume can be supplied. In another example, the sales person may tentatively agree to a volume discount that requires approval from one or more managers. This can cause a new workflow for a business approval process to be initiated based on the phone call dialog. Thus, dialogs and workflows can be interrelated in various ways according to business logic 134 such that workflows can trigger dialogs and dialogs can in turn trigger child dialogs and/or new workflows. Having dialogs that can be created in a not-started state facilitates this interrelation by providing a mechanism that enables automated assignment and scheduling of the dialogs 132.

At step 408, a determination is made regarding whether the dialog is paused before being completed. As noted previously, a pause-resume option can be provided that when selected initiates a pause-resume loop as indicated by step 410. This approach can enable a user to complete a dialog through multiple passes rather than using a single pass. For example, after interacting to input information specified by the dialog, a user can supply input to pause the dialog that is resumed. This can occur at any suitable point within a dialog using for example a pause button, menu item, or other suitable control selectable to pause the dialog.

In the pause-resume loop, the dialog session is paused by placing the session back into a not-started state. The system CRM system can be configured to monitor for input to resume the paused dialog session. In at least some examples, pausing the dialog causes the dialog to appear within the list of pending tasks as a paused dialog. As shown in FIG. 4, the pause-resume loop loops back to step 402 where steps 402-408 to resume and process the paused dialog session can be repeated in the manner previously described. One or more such iterations through the pause-resume loop can occur until it is determined at step 408 that the dialog is completed (e.g., not paused).

Upon completion of the dialog per step 408, step 412 communicates results regarding the dialog to cause the CRM system to continue actions for the workflow. For example, after interacting to input information specified by the dialog, a user can supply input to indicate completion of the dialog that is resumed. This may occur for example when a user selects a control to submit the dialog, selects a next page button, closes out the dialog interface, or otherwise concludes the particular interaction activity. This causes a communication to be sent to the CRM system to notify the CRM system of the completed dialog and provide results of the dialog.

The communication can be configured in various ways using any suitable messages and messaging techniques. For instance, data obtained through the dialog can be communicated as XML data through a post operation. In general, the communication notifies the CRM system 120 that the dialog has been completed and also submits data that can be stored as part of the business process record. Data can be stored for example as client data 128. Completion of the dialog and corresponding results can also drive further actions in the workflow 130 as described in relation to FIG. 3.

Having considered various example methods for not-started CRM dialogs, consider now an example system that can be employed to implement various aspects of not-started CRM dialogs in accordance with one or more embodiments.

Example System

FIG. 5 illustrates an example system generally at 500 that includes an example computing device 502 that is representative of one or more such computing systems and/or devices that may implement the various embodiments described above. The computing device 502 may be, for example, a server of a service provider 114, a device associated with the client 102 (e.g., a client device), an on-chip system, and/or any other suitable computing device or computing system.

The example computing device 502 includes one or more processors 504 or processing units, one or more computer-readable media 506 which may include one or more memory and/or storage components 508, one or more input/output (I/O) interfaces 510 for input/output (I/O) devices, and a bus 512 that allows the various components and devices to communicate one to another. Computer-readable media 506 and/or one or more I/O devices may be included as part of, or alternatively may be coupled to, the computing device 502. The bus 512 represents one or more of several types of bus structures, including a memory bus or memory controller, a peripheral bus, an accelerated graphics port, and a processor or local bus using any of a variety of bus architectures. The bus 512 may include wired and/or wireless buses.

The one or more processors 504 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. The memory/storage component 508 represents memory/storage capacity associated with one or more computer-readable media. The memory/storage component 508 may include volatile media (such as random access memory (RAM)) and/or nonvolatile media (such as read only memory (ROM), Flash memory, optical disks, magnetic disks, and so forth). The memory/storage component 508 may include fixed media (e.g., RAM, ROM, a fixed hard drive, etc.) as well as removable media (e.g., a Flash memory drive, a removable hard drive, an optical disk, and so forth).

Input/output interface(s) 510 allow a user to enter commands and information to computing device 502, and also allow information to be presented to the user and/or other components or devices using various input/output devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software, hardware (fixed logic circuitry), or program modules. Generally, such modules include routines, programs, objects, elements, components, data structures, and so forth that perform particular tasks or implement particular abstract data types. An implementation of these modules and techniques may be stored on or transmitted across some form of computer-readable media. The computer-readable media may include a variety of available medium or media that may be accessed by a computing device. By way of example, and not limitation, computer-readable media may include “computer-readable storage media” and “communication media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. Computer-readable storage media also includes hardware elements having instructions, modules, and/or fixed device logic implemented in a hardware form that may be employed in some embodiments to implement aspects of the described techniques.

The computer-readable storage media includes volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, hardware elements (e.g., fixed logic) of an integrated circuit or chip, or other storage device, tangible media, or article of manufacture suitable to store the desired information and which may be accessed by a computer.

“Communication media” may refer to a signal bearing medium that is configured to transmit instructions to the hardware of the computing device, such as via the network 112. Communication media typically may embody computer readable instructions, data structures, program modules, or other data in a modulated data signal, such as carrier waves, data signals, or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

Combinations of any of the above are also included within the scope of computer-readable media. Accordingly, software, hardware, or program modules, including the CRM web service 122 and other components of a CRM system 120, applications 108, communication module 110, and other program modules, may be implemented as one or more instructions and/or logic embodied on some form of computer-readable media.

Accordingly, particular modules, functionality, components, and techniques described herein may be implemented in software, hardware, firmware and/or combinations thereof. The computing device 502 may be configured to implement particular instructions and/or functions corresponding to the software and/or hardware modules implemented on computer-readable media. The instructions and/or functions may be executable/operable by one or more articles of manufacture (for example, one or more computing devices 502 and/or processors 504) to implement techniques for not-started CRM dialogs, as well as other techniques. Such techniques include, but are not limited to, the example procedures described herein. Thus, computer-readable media may be configured to store or otherwise provide instructions that, when executed by one or more devices described herein, cause various techniques for not-started CRM dialogs.

Conclusion

Various embodiments provide not-started CRM dialogs that facilitate dialog management in a cooperative manner between a CRM system and a client. A workflow defining a set of actions to complete for a business process can trigger a dialog in a “not-started” state and assign the dialog to a particular user. The dialog that is assigned can appear in a list of scheduled/pending tasks for the particular user and can include a link or other functionality to resume the dialog. Selection of the dialog from the task list can cause the dialog to resume to an “in-progress” state. Thereafter, the workflow can detect completion of the dialog and continue with further actions to complete the business process

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims

What is claimed is:

1. One or more computer-readable storage media storing instructions, that when executed by a computing device, cause the computing device to implement an customer relationship management (CRM) system configured to perform acts comprising:
triggering a workflow for a business process record in the CRM system, the workflow configured to automate a set of actions defined by the workflow for a corresponding business process;
initiating a dialog associated with the workflow in a not-started state, the dialog configured to facilitate completion of one or more activities for the corresponding business process that are driven by user inputs;
monitoring for completion of the dialog; and
continuing with actions defined by the workflow responsive to completion of the dialog.

2. The one or more computer-readable storage media of claim 1, further comprising;
assigning the dialog in the not-started state to a particular user; and
informing the particular user regarding the assigned dialog.

3. The one or more computer-readable storage media of claim 2, wherein informing the particular user regarding the assigned dialog comprises causing a list of pending tasks corresponding to the particular user to include a task for the assigned dialog.

4. The one or more computer-readable storage media of claim 3, further comprising configuring the task for the assigned dialog to include functionality operable to navigate to the dialog and resume the dialog from the not-started state to an in-progress state.

5. The one or more computer-readable storage media of claim 2, wherein informing the particular user regarding the assigned dialog comprises sending a notification of the assigned dialog to the particular user.

6. The one or more computer-readable storage media of claim 5, further comprising configuring the notification to include functionality operable to navigate to the dialog and resume the dialog from the not-started state to an in-progress state.

7. The one or more computer-readable storage media of claim 1, further comprising pausing the workflow pending completion of the dialog.

8. The one or more computer-readable storage media of claim 1, further comprising completing at least some of the actions defined by the workflow for a corresponding business process pending completion of the dialog.

9. The one or more computer-readable storage media of claim 1, wherein monitoring for completion of the dialog comprises monitoring for a communication configured to indicate that the dialog is completed and submit results for the dialog.

10. The one or more computer-readable storage media of claim 1, wherein:
at least some of the actions defined by the workflow are dependent actions that depend upon the results for the dialog; and
continuing with actions defined by the workflow comprises selectively performing the dependent actions based on the results.

11. A computer implemented method comprising;
initiating a dialog for a workflow in a customer relationship management (CRM) system in a not-started state;
assigning the dialog in the not-started state to a particular user including at least causing a list of pending tasks corresponding to the particular user to include a task for the assigned dialog;
detecting completion of the dialog; and
performing one or more actions defined by the workflow based upon results of the dialog.

12. The computer implemented method of claim 11, wherein the dialog is configured to be selectable via the list of pending tasks to resume the dialog from the not-started state to an in-progress to guide the particular user through completion of an activity corresponding to the workflow.

13. The computer implemented method of claim 11, wherein the list of pending tasks is configured as a list for a personal information management (PIM) application.

14. The computer implemented method of claim 11, wherein detecting completion of the dialog comprises obtaining a communication including the results of the dialog.

15. The computer implemented method of claim 11, wherein the workflow is configured to automate a set of actions defined by the workflow for a corresponding business process.

16. The computer implemented method of claim 11, further comprising:
performing at least some actions defined by the workflow automatically pending completion of the dialog until a stopping point is reached; and
pausing the workflow at the stopping point to await results of the dialog.

17. The computer implemented method of claim 11, further comprising configuring the dialog to selectively initiate a child dialog in a non-started state based upon one or more triggers encoded in the dialog,

18. A computer implemented method comprising;
outputting a list of pending tasks assigned by a customer relationship management (CRM) system in connection with a workflow, the workflow configured to automate a set of actions defined by the workflow for a corresponding business process;
obtaining a selection via the list to start a particular task associated with a dialog in a not-started state;
causing the dialog to resume from the not-started state to an in-progress state in response to the selection;
receiving input through the dialog to complete the dialog; and
communicating results regarding the dialog to cause the CRM system to continue with actions defined by the workflow.

19. The computer implemented method of claim 18, wherein the workflow is configured to create the dialog and assign the dialog to a particular user including causing the particular task associated with the dialog in the not-started state to appear in the list of pending tasks.

20. The computer implemented method of claim 18, wherein the dialog is configured to facilitate completion of one or more activities for the corresponding business process that are driven by user inputs.
